(19) United States
(12) Patent Application Publication
(10) Pub. No.: US 2022/0284300 A1
(43) Pub. Date: Sep. 8, 2022

(54) TECHNIQUES TO TUNE SCALE PARAMETER FOR ACTIVATIONS IN BINARY NEURAL NETWORKS

(71) Applicant: INTEL CORPORATION, Santa Clara, CA (US)

(72) Inventors: Konstantin RODYUSHKIN, Nishny Novgorod (RU); Alexey KRUGLOV, Nizhny Novgorod (RU)

(73) Assignee: INTEL CORPORATION, Santa Clara, CA (US)

(21) Appl. No.: 17/636,023

(22) PCT Filed: Sep. 19, 2019
(86) PCT No.: PCT/IB2019/000996

§ 371 Date: Feb. 16, 2022

(51) Int. Cl. G06N 3/08; G06N 3/04

(52) U.S. Cl. CPC G06N 3/084; G06N 3/0481

(57) ABSTRACT

Various embodiments are generally directed to techniques to tune a scale parameter for activations in binary neural networks, such as based on estimating a gradient for the scale parameter using quantization error, for instance. Some embodiments are particularly directed to tuning the scale parameter for activations by estimating the gradient for the scale parameter using a first “force” based on quantization error and a second, opposing, “force” based on clipping error. For instance, the first “force” based on the quantization error may give a gradient for the scale parameter that pushes the scale parameter lower to reduce the quantization error and the second “force” based on the clipping error may give a gradient for the scale parameter that moves the scale parameter higher to reduce the number of activations that are higher than a current scale parameter.

### BACKGROUND

Artificial neural networks, or simply neural networks, generally refer to computing systems that are inspired by biological neural networks, such as animal brains. Typically, neural networks progressively improve performance on a task by considering examples of the task. For instance, in image recognition, a neural network may learn to identify images that contain cats by analyzing learning materials, such as example images that have been labeled as “cat” or “no cat”, and using the results to identify cats in other images. Usually, the neural network evolves its own set of relevant characteristics of the images from the learning material they process without any prior knowledge about the task. Accordingly, in the above instance, the neural network may evolve a set of relevant characteristics to determine whether an image includes a cat without any prior knowledge about cats (e.g., they have fur, tails, whiskers, etc.). Characteristically, neural networks include a collection of connected nodes, referred to as artificial neurons, that are modeled based on biological neurons. Connections between the nodes, a simplified version of a biological synapse, can transmits signals between connected nodes. A binary neural network may refer to a neural network with binary weights and activations at run-time.

### BRIEF DESCRIPTION OF THE DRAWINGS

FIG. 1 illustrates a first exemplary operating environment for a binary neural network trainer according to one or more embodiments described herein.

FIG. 2 illustrates exemplary aspects of a scale parameter tuner according to one or more embodiments described herein.

FIG. 3 illustrates exemplary process flow of a quantization error aware activation binarization layer forward and back propagations according to one or more embodiments described herein.

FIG. 4 illustrates an exemplary logic flow according to one or more embodiments described here.

FIG. 5 illustrates an embodiment of a storage medium according to one or more embodiments described herein.

FIG. 6 illustrates an embodiment of a computing architecture according to one or more embodiments described herein.

FIG. 7 illustrates an embodiment of a communications architecture according to one or more embodiments described herein.

### DETAILED DESCRIPTION

Various embodiments are generally directed to techniques to tune a scale parameter for activations in binary neural networks, such as based on estimating a gradient for the scale parameter using quantization error, for instance. Some embodiments are particularly directed to tuning the scale parameter for activations by estimating the gradient for the scale parameter using a first “force” based on quantization error and a second, opposing, “force” based on clipping error. For instance, the first “force” based on the quantization error may give a gradient for the scale parameter that pushes the scale parameter lower to reduce the quantization error and the second “force” based on the clipping error may give a gradient for the scale parameter that moves the scale parameter higher to reduce the number of activations that are higher than a current scale parameter. In many embodiments, the two opposing “force”s may cause the scale parameter to be stabilized on a level that balances clipping and quantization errors together. In several embodiments, stabilization of the scale parameter by balancing the clipping and quantization errors may occur automatically during stochastic gradient descent training. These and other embodiments are described and claimed.

Some challenges facing neural networks include the need for large amounts of computational power. This need for large amounts of computational power limits the use of neural networks in real-time applications on the edge. One way to reduce the amount of computational power required includes generating neural networks in binary form (i.e. binary neural networks) where activations and weights can only take two values (e.g., −1 or +1). In this case, expensive 32-bit float point multiplications and accumulation operations can be replaced with a single 32-bit integer XNOR (or XOR) plus one “bitcount” operation. This can lead to a significant boost on most hardware architectures (up to 32× speedup theoretically).

However, efficiently training a useful and accurate binary neural network can be an exceedingly hard and complex task. For example, the non-continuous activations and weights in binary neural networks can drastically complicate training. Further, directly converting each input activation value into fixed levels {−1, +1} leads to significant drops in accuracy due to the strong limitation to represent the original 32-bit floating point signals as one of two values (e.g., −1 or +1). For instance, directly converting each input activation value into fixed levels {−1, +1} has been shown to cause around a 19% drop in accuracy for resnet18. This difficulty with training binary neural networks has led to specialized training techniques for binary neural networks. One way to improve the training is by optimization of the scale parameter. In various embodiments, the scale parameter may define the binary level for activation on each layer of a binary neural network. However, optimization of the scale parameter presents its own challenges.

Challenges facing optimization of the scale parameter include the need for extensive manual expertise, the introduction of additional hyperparameters, and/or overestimation of the scale parameter. For example, by only allowing activations with a value more than a current scale parameter to be used in tuning the scale parameter can lead to overestimation of the scale parameter. Additionally, or alternatively, to avoid overestimation of the scale parameter a scale parameter decay approach may be used, but this approach requires an additional hyperparameter that must be manually tuned, which requires expertise in the area and can be exceedingly difficult. Further, the scale parameter decay approach may not be effective for 1-bit activation quantization (i.e., binary activation). This ineffectiveness can be due to the large quantization error for one bit. For instance, the binarized version of ResNet-18 network trained using the scale parameter decay approach has been shown to achieve only 44% validation accuracy on the ImageNet dataset. These and other factors may result in neural networks with excessive resource demand, limited applicability, and poor adaptability. Such limitations can drastically reduce the usability and performance of neural networks, contributing to inefficient systems, devices, and techniques with reduced applicability.

Various embodiments described herein include the ability to efficiently train binary neural networks, such as binary convolutional neural networks, with increased accuracy. In several embodiments, training may be improved by including techniques to optimize the scale parameter as part of an activation quantization/binarization procedure. Many embodiments described herein may include an advantageous neural network quantization method that produces high accuracy neural networks based on a novel procedure of parameter estimation. In some embodiments, this may include automatic optimization of the scale parameter for activations in binary neural networks. In various embodiments, quantization error and/or clipping error may be utilized to effectively optimize the scale parameter. In several embodiments, the scale parameter may be stabilized at an optimal level that balances the clipping and quantization errors together. Embodiments that take the quantization error into account in addition to the clipping error may, for instance, achieve over a 12% increase in accuracy on ResNet-18 than when clipping error alone is accounted for. In various embodiments, balancing the clipping and quantization errors may occur during stochastic gradient descent training. In some embodiments, the clipping error and quantization error may be utilized in opposing “force”s to tune the scale parameter.

For example, a first “force” based on the clipping error (or activation clipping error) may give, or be used to estimate, a gradient for scale that moves the scale parameter higher to reduce the number of activations that are higher than a current scale and a second “force” based on quantization error, which usually grows as scale increases, may give, or be used to estimate, a gradient for scale that pushes the scale parameter lower to reduce quantization error. In various embodiments, techniques described herein may avoid the need for complex tuning of one or more additional hyperparameters, resulting in simpler and more efficient neural networks. Many embodiments may increase convergence speed, such as by parameterizing scale to make optimization adjustments, or steps, larger for high scale values and smaller for low scale values for adaptive optimization algorithms (e.g., Adam). The same or similar techniques may be used for parameterizing threshold.

In these and other ways, components described herein may increase effectiveness, decrease performance costs, decrease computational cost, improve accuracy, and/or reduce resource requirements to implement neural networks, in accurate, efficient, dynamic, and scalable manners, resulting in several technical effects and advantages over conventional computer technology, including increased capabilities and improved adaptability. For instance, these advantages over conventional computer technology may enable the use of neural networks in real-time application on the edge. In various embodiments, one or more of the aspects, techniques, and/or components described herein may be implemented in a practical application via one or more computing devices, such as to expand applicability of and/or access to neural networks, and thereby provide additional and useful functionality to the one or more computing devices, resulting in more capable, better functioning, and improved computers. Further, one or more of the aspects, techniques, and/or components described herein may be utilized to improve the technical field of machine learning, neural networks, parameter tuning, gradient estimation, and/or binary neural networks.

In several embodiments, components described herein may provide specific and particular manners of training/generating neural networks and/or tuning parameters thereof. These specific and particular manners of training neural networks and/or tuning parameters thereof may include, for instance, estimating a gradient for a scale parameter associated with activations in a neural network based on a quantization error. In many embodiments, one or more of the components described herein may be implemented as a set of rules that improve computer-related technology by allowing a function not previously performable by a computer that enables an improved technological result to be achieved. For example, the function allowed may include automatically tuning a scale parameter based on opposing “force”s. One or more of these techniques may enable creation of high accuracy binary neural networks that can work on low performance/power hardware with good quality. For instance, binary neural networks produced with one or more of these techniques can require dramatically less (e.g., 50% or less) computational resource when compared with original FP32 nets.

With general reference to notations and nomenclature used herein, one or more portions of the detailed description, which follows, may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

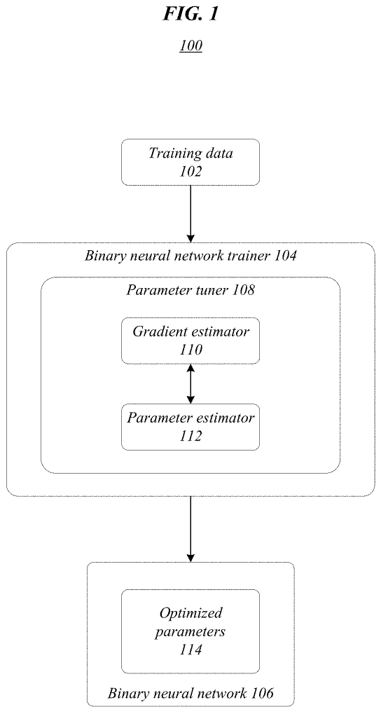

FIG. 1 illustrates an exemplary operating environment 100 for a binary neural network trainer 104 according to one or more embodiments described herein. Operating environment 100 may include training data 102, binary neural network trainer 104, and binary neural network 106. In the illustrated embodiment, binary neural network trainer 104 may include a parameter tuner 108 with a gradient estimator 110 and a parameter estimator 112. Also, the binary neural network 106 may include one or more optimized parameters 114 as determined by parameter tuner 108, such optimized parameters 114 may include one or more of scale parameters, binary convolution weights, binarization thresholds, continuous convolutionion weights, and any other parameters estimated for the binary neural network 106. In one or more embodiments described herein, the binary neural network trainer 104 may implement a neural network quantization method tat produces high accuracy binary neural nets with one or more optimized parameters 114 based on training data 102, such as using an improved procedure for scale parameter estimation (e.g., activation quantization/binarization procedure) that accounts for quantization error (e.g., binarization error). In many embodiments, one or more components of operating environment 100 may be implemented as part of a quantization error aware activation binarization layer. Embodiments are not limited in this context.

In one or more embodiments, binary neural network trainer 104 may receive training data 102 as input and produce binary neural network 106 as output. In many embodiments, training data 102 may include a set of images and metadata for the set of images (e.g., labels). For example, the training data 102 may include a set of images with labels indicating whether or not each image includes a boat. In such examples, binary neural network trainer 104 may utilize the training data 102 to train, or generate, binary neural network 106 to classify whether unlabeled images provided as input include a boat. More generally, in several embodiments, binary neural network trainer 104 may be used to produce one or more binary neural networks (e.g., binary neural network 106) for computer vision and/or deep learning applications. In many embodiments, binary neural network 106 may comprise any type of machine learning neural network, such as a deep neural network, a convolutional neural network (CNN), or the like. In various embodiments, in addition, or alternative, to training data 102, binary neural network trainer 104 may receive one or more pretrained weights for neural network weight initialization. In embodiments that the binary neural network trainer 104 does not receive pretrained weights, network weights may be initialized with random values using an initialization method (e.g., Xavier initialization). In some embodiments, pretraining, or utilizing, one or more weights for neural network weight initialization may result in more efficient training that results in more accurate binary neural networks.

In many embodiments, binary neural network trainer 104 may utilize parameter tuner 108 to determine one or more optimized parameters 114 for activations in the binary neural network 106, such as part of an activation quantization/binarization procedure. In various embodiments, the one or more optimized parameters 114 may define an optimized binary level for activation on each layer in the binary neural network 106. In some embodiments, a different optimized scale parameter may be determined for each binary activation layer, or each set of binary activation layers, in binary neural network 106. In other embodiments, a common optimized scale parameter may be determined for all binary activation layers in binary neural network 106.

In several embodiments, determination of one or more optimized parameters 114 may be based on one or more scale parameter estimations (e.g., via parameter estimator 112). In several such embodiments, the one or more scale parameter estimations may be determined using one or more gradient estimations for the scale parameter (e.g., via gradient estimator 110). For example, scale parameter tuner 104 of binary neural network trainer 104 may determine the one or more optimized parameters 114 for activations in binary neural network 106 by estimating the gradient for a current scale parameter using a first “force” based on quantization error and a second, opposing, “force” based on clipping error. In such examples, the first “force” based on the quantization error may give a gradient for the scale parameter that pushes the scale parameter lower to reduce the quantization error and the second “force” based on the clipping error may give a gradient for the scale parameter that moves the scale parameter higher to reduce the number of activations that are higher than a current scale parameter. In various embodiments described here, “force” is included in quotations because it is used as a term of convenience and does not necessarily relate to any mathematically/physically accurate force.

In many embodiments, the two opposing “force”s may cause the scale parameter to be stabilized on a level that balances clipping and quantization errors together. In several embodiments, stabilization of the scale parameter by balancing the clipping and quantization errors may occur automatically during stochastic gradient descent training. More generally, gradient estimator 110 may estimate a gradient for the scale parameter during backpropagation and the gradient estimations may then be used by parameter estimator 112 to update an intermediary estimation of the one or more optimized parameters 114, such as the scale parameter, Sₗₙ, and/or the threshold parameter, Tₛ.

Back propagation may include a family of techniques used to train neural networks following a gradient descent approach that exploits the chain rule. In many embodiments, backpropagation may include an iterative and recursive method for updating weights. In the context of learning, backpropagation may be used by a gradient descent optimization algorithm to adjust the weights of neurons by calculating the gradient of the loss function. More specifically, backpropagation may compute the gradients, whereas stochastic gradient descent may use the gradients for training the model (e.g., binary neural network 106).

In many embodiments, update of the scale parameter and/or threshold parameter may be done in conjunction with update of one or more other parameters (e.g., weights) of the neural network being trained. Thus, in many such embodiments, the scale and threshold parameters may be updated in a main training loop, as opposed to a separate subloop inside or outside of the main training loop. In several embodiments, stages in the main training loop may include one or more of the following: (1) receiving a batch of training data; (2) a forward pass (inference) on the batch of training data and application of the loss function; (3) a backward pass, which estimates gradients for a plurality of trainable parameters, such as both network weights and binarization parameters; and (4) parameter update using the gradients for the batch of training data. These and other aspects of gradient and parameter estimation will be discussed in more detail below.

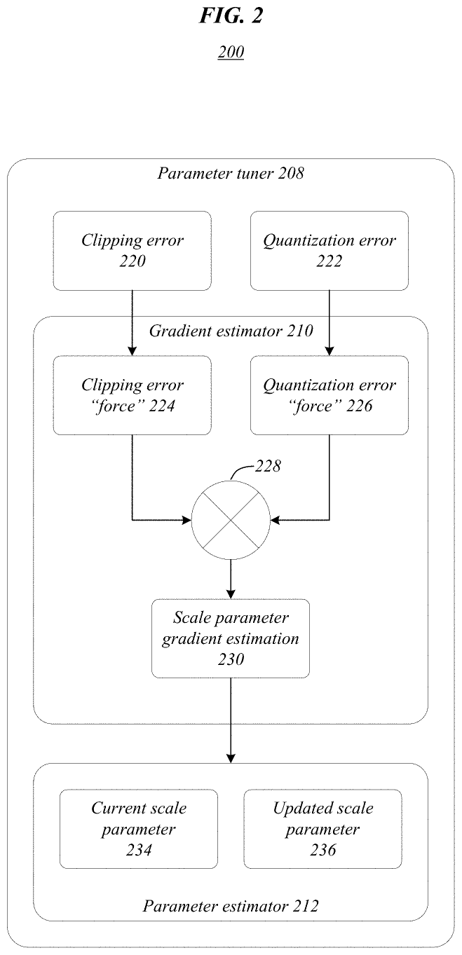

FIG. 2 illustrates exemplary aspects of a parameter tuner 208 in environment 200 according to one or more embodiments described herein. In many embodiments, one or more components of environment 200 may be the same or similar to components of operating environment 100. For instance, parameter tuner 208 may be the same or similar to parameter tuner 108. Environment 200 may include parameter tuner 208 with gradient estimator 210, parameter estimator 212, clipping error 220, and quantization error 222. In one or more embodiments described herein, gradient estimator 210 may utilize the clipping error 220 and the quantization error 222 to input a parameter gradient to parameter estimator 212 for generating/revising parameter estimations. It will be appreciated that although gradient and parameter estimation is only illustrated with respect to the scale parameter, the same or similar process may be implemented to update other parameters for the network being trained, such as the threshold parameter. In many embodiments, one or more components of parameter tuner 208 may be implemented as part of a quantization error aware activation binarization layer. Embodiments are not limited in this context.

As shown in the illustrated embodiment, gradient estimator 210 includes clipping error “force” 224, quantization error “force” 226, accumulator 228, and scale parameter gradient estimation 230. In several embodiments, parameter tuner 208 may include and/or implement one or more aspects of an activation quantization/binarization procedure. In some embodiments, gradient estimator 210 may determine clipping error “force” 224 based on clipping error 220 and quantization error “force” 226 based on quantization error 222. For example, clipping error “force” 224 may be the gradient of the loss/error function over the scale parameter due to clipping error 220. In an additional, or alternative, example, the quantization error “force” 226 may be the gradient of the loss/error function over the scale parameter due to quantization error 222. As described in more detail below, in many embodiments, calculating the gradient due to the quantization error “force” and the clipping error “force” may be calculated according to:

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

In some embodiments, the clipping error 220, or activation clipping error, may refer error introduced by clipping limiting input to a range of values. For example, the clipping error 220 may comprise the error introduced by limiting input activations to a range between 0 and 0.8. In many embodiments, the quantization error 222, or binarization error, may refer to error introduced by the spacing created when continuous values are converted into discrete values. For instance, the quantization error 222 may comprise the error introduced by converting continuous-valued input activations into binary-valued input activations.

In several embodiments, the clipping error “force” 224 may give a gradient for the scale parameter that moves the scale parameter higher to reduce the number of activations that are higher than the current scale parameter 234 and the quantization error “force” 226 may give a gradient for the scale parameter that pushes the current scale parameter 234 lower to reduce the quantization error 222. In many embodiments, these two opposing “force”s may cause the scale parameter to be stabilized on a level that balances the clipping error 220 and the quantization error 222 together. In many such embodiments, stabilization of the scale parameter by balancing the clipping and quantization errors may occur automatically during stochastic gradient descent training.

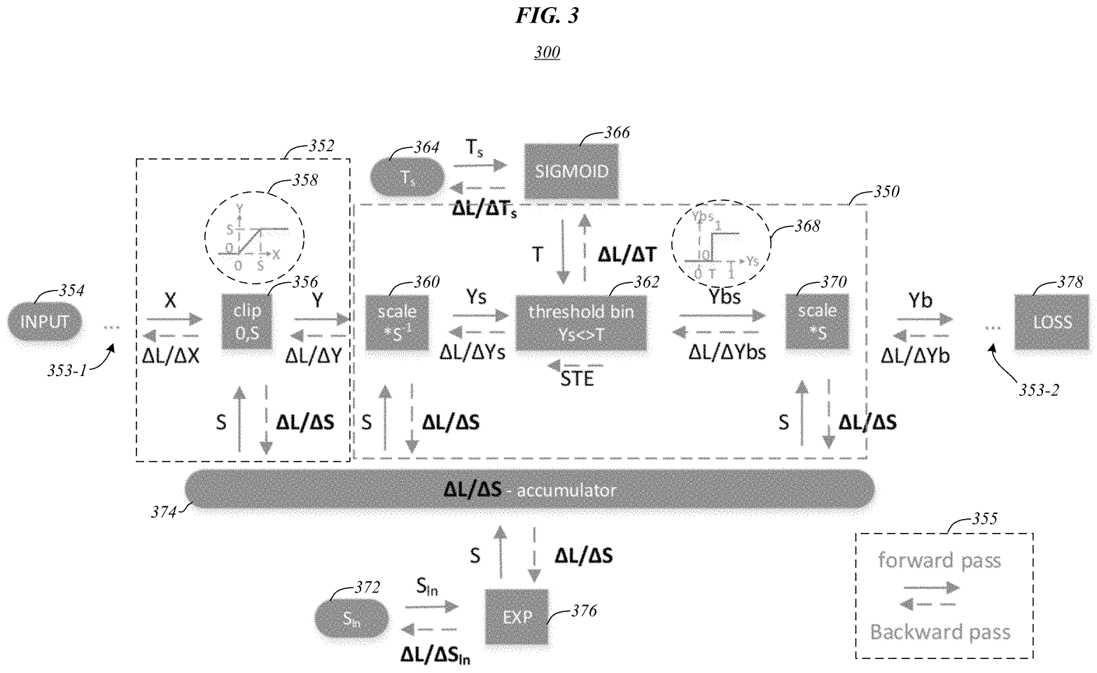

In one or more embodiments, accumulator 228 may sum the clipping error “force” 224 and the quantization error “force” 226 to generate scale parameter gradient estimation 230. In several embodiments, the scale parameter gradient estimation 230 may be used by parameter estimator 212 to produce updated scale parameter 236. In several such embodiments, the parameter estimator 212 may use the scale parameter gradient estimation 230 in conjunction with the current scale parameter 234 to produce updated scale parameter 236. In many embodiments, this process may be recursively and/or iteratively performed until an optimized scale parameter (e.g., one or more optimized parameters 114) is arrived at. These and other aspects of gradient and parameter estimation will be discussed in more detail below, such as in conjunction with FIG. 3.

FIG. 3 illustrates an exemplary process flow 300 of a quantization error aware activation binarization layer forward and back propagations according to one or more embodiments described herein. In one or more embodiments, process flow 300 may illustrate a training procedure with an improved way of estimating scale parameter for activation (e.g., activation quantization/binarization procedure). Process flow 300 may estimate the gradient over the scale parameter based on clipping error and quantization error. In many embodiments, process flow 300 may form one or more portions of training a neural network (e.g., binary neural network 106). In several embodiments, utilizing gradients due to quantization error may prevent over estimation of the scale parameter that can result from only utilizing gradients due to clipping error. Accordingly, process flow 300 allows stochastic gradient descent methods to tune the scale parameter to a value defined by the balance between clipping error and quantization error. Embodiments are not limited in this context.

One or more embodiments described herein may utilize activation binarization using scale parameter optimized by stochastic gradient descent loop with gradient for scale parameter, or scale gradient (ΔL/ΔS), based on quantization error and/or clipping error. In many embodiments, the gradient due to the quantization error and the clipping error may be calculated according to:

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

More generally, the process flow 300 may include a forward pass indicated with solid arrows and backward pass indicated with dashed arrows (see e.g., box 355). Further, aspects of process flow 300 illustrated within box 350 may be associated with quantization error and/or aspects of process flow 300 illustrated within box 352 may be associated with clipping error.

In the illustrated embodiment, the continuation marking 353-1 beside input 354 and the continuation marking 353-2 beside loss 378 indicate one or more additional layers that may be included in process flow 300, but are not illustrated in FIG. 3. In some embodiments, one or more of the additional layers indicated by continuation marking 353-1 may include one or more continuous-valued activation layers and/or one or more of the additional layers indicated by continuation marking 353-2 may include one or more binary-valued activation layers. In many embodiments, process flow 300 may be implemented via binary neural network trainer 104.

In many embodiments described herein, a forward pass, or forward propagation, of process flow 300 may be summarized as generating a binary-valued output activation, Y_{b}, based on a continuous-valued input activation, X, an input threshold state, Tₛ, and the input scale natural log, Sₗₙ. Various embodiments herein include one or more aspects of the forward pass of process flow 300 illustrated in FIG. 3 and/or described below. In various embodiments, input 354 (e.g., a sample from training data 102) may arrive at the clipping error box 352 as continuous-valued input activation, X, after forward propagating through the one or more additional layers indicated by continuation marking 353-1.

In one or more embodiments, the clipping error box 352 may convert the continuous-valued input activation, X, into a continuous-valued output activation, Y, based on input scale, S. For example, clipping function 356 may implement ramp function 358 based on the input scale, S. In many embodiments, accumulator 374 may not be involved in the forward pass. In many embodiments, the input scale, S, (e.g., scale parameter input value) can be provided to the accumulator 374 by passing the input scale natural log 372, Sₗₙ, through exponentiation function 376. In many embodiments, the exponentiation function 376 may be utilized to parameterize the input, such as to increase convergence speed by making optimization adjustments/steps larger for high scale values and smaller for low scale values. For example, scale may be parameterized to make optimization adjustments larger for larger scale values and smaller for scale values proximate to 0. In an additional, or alternative, example, scale may be parameterized to make optimization adjustment/step size proportional, or approximately proportional, to scale value. In such examples, this may make adjustment size larger for larger scale values and smaller for scale values proximate to 0. In one or more embodiments, the exponentiation function 376 may operate according to S=e^{S}^{ᵢₙ}.

In several embodiments, the quantization error box 350 may receive the continuous-valued output activation, Y, and generate binary-valued output activation, Y_{b}, based on threshold, T, and input scale, S. For instance, inverse scale function 360 may convert continuous-valued output activation, Y, to continuous-valued output activation, Yₛ, based on input scale, S; threshold bin 362 may convert continuous-valued output activation, Yₛ, into binary-valued output activation, Y_{bs} based on threshold, T, such as by implementing quantization function 368; and direct scale function 370 may convert binary-valued output activation, Y_{bs}, into binary-valued output activation, Y_{b}, based on input scale, S. In one or more embodiments, the threshold bin 362 may map activations to a binary value based on a comparison with threshold, T (e.g., threshold parameter input value). In various embodiments, binary-valued output activation, Y_{b}, may adhere to the following

$${Y}_{b} = \{ \begin{matrix}0 & for & X \leq T \cdot S \\ S & for & X > T \cdot S\end{matrix}$$

In some embodiments, the threshold, 7′, can be provided to the quantization error box 366 (e.g., threshold bin 362) by passing the input threshold state, Tₛ, through sigmoid function 366. In many embodiments, the sigmoid function 366 may be utilized to parameterize the threshold, such as to increase convergence speed by making optimization adjustments larger for threshold values that are closer to 0.5 and smaller for threshold values that are closer to 0 or 1. In one or more embodiments, the sigmoid function 366 may operate according to T=sigmoid(Tₛ), where

$$sigmoid ( {T}_{s} ) = \frac{1}{1 + {e}^{- {T}_{s}}} .$$

From the quantization error box 350, the binary-valued output activation, Y_{b}, may forward propagate through the one or more additional layers indicated by continuation marking 353-2 and then be utilized in determination of the loss 378, such as via application of a loss function.

In many embodiments, once the loss 378 is determined a backward pass may begin. In one or more embodiments described herein, a backward pass, or backward propagation, of process flow 300 may be summarized as generating/estimating an input activation gradient, ΔL/ΔX, a scale gradient, ΔL/ΔSₗₙ, and a threshold gradient, ΔL/ΔTₛ, based on the output activation gradient, ΔL/ΔY_{b}. Various embodiments herein include one or more aspects of the backward pass of process flow 300 illustrated in FIG. 3 and/or described below. In various embodiments, loss 378 may arrive at the quantization error box 350 as output activation gradient, ΔL/ΔY_{b}, after backward propagating through the one or more additional layers indicated by continuation marking 353-2.

In one or more embodiments, the quantization error box 350 may convert the output activation gradient, ΔL/ΔY_{b}, into first and second scale gradient contributions, ΔL/ΔS, a continuous-valued output activation gradient, ΔL/ΔY, and threshold gradient contribution, ΔL/ΔT. For instance, direct scale function 370 may generate the first scale gradient contribution, ΔL/ΔS, and binary-valued output activation gradient, ΔL/ΔY_{bs}, based on output activation gradient, ΔL/ΔY_{b}; threshold bin 362 may generate threshold gradient contribution, ΔL/ΔT, and continuous-valued output activation gradient, ΔL/ΔYₛ, based on binary-valued output activation gradient, ΔL/ΔY_{bs}; and inverse scale function 360 may generate the second scale gradient contribution, ΔL/ΔS, and the continuous-valued output activation gradient, ΔL/ΔY, based on continuous-valued output activation gradient, ΔL/ΔYₛ. In many embodiments, the threshold gradient contribution, ΔL/ΔT, may backward propagate through exponentiation function 376 to produce threshold gradient, ΔL/ΔTₛ.

In one or more embodiments, the clipping error box 352 may convert the continuous-valued output activation gradient, ΔL/ΔY, into a third scale gradient contribution, ΔL/ΔS, and an input activation gradient, ΔL/ΔX. For example, clipping function 356 may generate the third scale gradient contribution, ΔL/ΔS, and the input activation gradient, ΔL/ΔX, based on the continuous-valued output activation gradient, ΔL/ΔY. From the clipping error box 352, the input activation gradient, ΔL/ΔX, may backward propagate through the one or more additional layers indicated by continuation marking 353-1 and/or be utilized in characterization of input 354, such as for model testing/validation.

In various embodiments, accumulator may sum the first and second scale gradient contributions generated by quantization error box 350 and the third scale gradient contribution generated by clipping error box 352. The sum of the first and second scale gradient contributions may be calculated according to:

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

In some embodiments, the sum of the first and second scale gradient contributions may be the same to similar to the quantization error “force” 226 and/or the third scale gradient contribution may be the same or similar to the clipping error “force” 224. In several embodiments, the summed scale gradient contributions may comprise, or be utilized to generate, the scale parameter gradient estimation 230. In many embodiments, the summed scale gradient contributions may backward propagate through exponentiation function 376 to produce scale gradient, ΔL/ΔSₗₙ. In several embodiments, the scale gradient, ΔL/ΔSₗₙ, may comprise, or be utilized to generate, the scale parameter gradient estimation 230.

As previously mentioned, in many embodiments, the threshold gradient contribution, ΔL/ΔT, may backward propagate through exponentiation function 376 to produce threshold gradient, ΔL/ΔTₛ. In many such embodiments, exponentiation function 376 may operate according to

ΔL/ΔTₛ=−S·ΔL/ΔX·sigmoid′(T_{S}),

where

$${sigmoid}^{′} ( {T}_{s} ) = \frac{{e}^{- {T}_{s}}}{{( 1 + {e}^{- {T}_{s}} )}^{2}} .$$

In various embodiments, input activation gradient, ΔL/ΔX, may adhere to the following

$$Δ L / Δ X = \{ \begin{matrix}0 & for & X \leq 0 \\ Δ L / Δ {Y}_{b} & for & 0 < X < S \\ 0 & for & X \geq S\end{matrix}$$

In many embodiments, scale gradient, ΔL/ΔSₗₙ, may adhere to the following

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

In one or more embodiments for testing one or more of the activation quantization/binarization procedures described herein, a ResNet-18 CNN may be modified by replacing all full precision (e.g., continuous-valued) convolutions except the first, the last, and shortcuts with binary convolutions. In such embodiments, the weights of binary filters in binary convolution may take values of −1 or +1, and input activation values can be converted to either 0 or S for each binary layer input. Such binary convolution may be calculated as XNOR+POPCOUNT operations plus scalar scale and bias for output activation. In one embodiment, this binary ResNet-18 was trained on ImageNet ILSVCR-2012 dataset using scale parameter estimation without accounting for quantization error and scale parameter estimation with accounting for quantization error. After 30 training epochs and testing on the ISLVRC- 2012 validation set, scale parameter estimation with accounting for quantization error demonstrated 57% accuracy while scale parameter estimation without accounting for quantization error demonstrated 44% accuracy.

Additionally, embodiments of scale parameter estimation with accounting for quantization error was test performed with different networks and/or different tasks, additional classification training of resnet 30, resnet 50, and mobilnet-v1 networks on ImageNet dataset and 2 SSD detectors with VGG and MobileNetv1 backbones on PASCAL VOC dataset. The results of which are presented in Table 1, below

TABLE 1

| | | Binary | | | |
|---|---|---|---|---|---|
| Net | Data set | operations | FP32 | Binary | diff |
| Resnet50 | ImageNet | 88% | 76.15% | 70.74% | 5.41% |
| | 1000cls | | | | |
| Resnet34 | ImageNet | 95% | 73.30% | 65.05% | 8.25% |
| | 1000cls | | | | |
| MobileNet- | ImageNet | 80% | 70.10% | 57.35% | 12.75% |
| v1 | 1000cls | | | | |
| SSD VGG | PASCAL | 93% | 77.00% | 74.82% | 2.18% |
| | VOC 20cls | | | | |
| SSD | PASCAL | 32% | 70.16% | 66.31% | 3.85% |
| MobileNet- | VOC 20cls | | | | |
| v1 | | | | | |

In Table 1, average accuracy/precision results for different binary networks trained using scale parameter estimation that accounts for quantization error; in each net some part of fp32 convolutions were replaced by binary ones (1 bit for activation and 1 bit for weight); the percent of replaced FLOPS is shown in the ‘binary operation’ column. The ‘FP32’ column shows original accuracy/precision; the ‘binary’ column shows accuracy/precision for the binary net; and the ‘diff’ column shows the change between the original accuracy/precision and the accuracy/precision for the binary net.

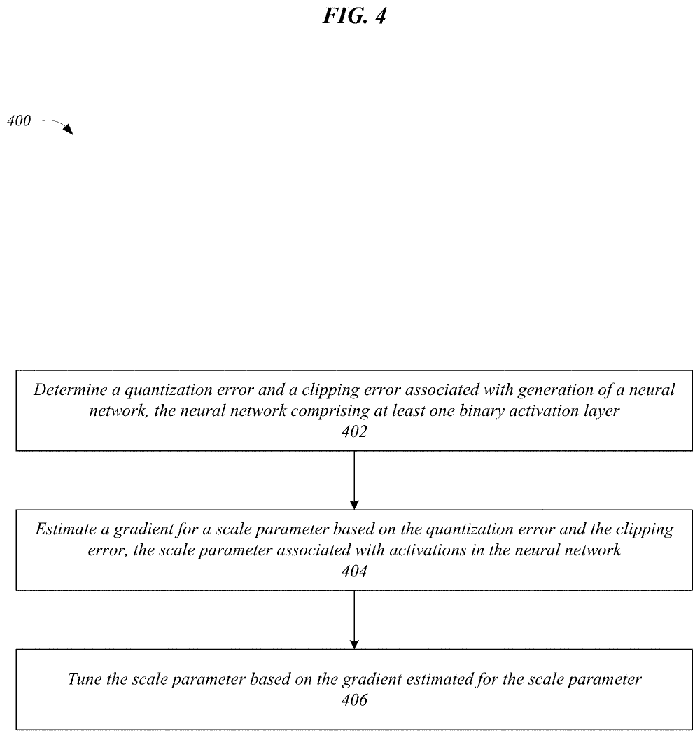

FIG. 4 illustrates one embodiment of a logic flow 400, which may be representative of operations that may be executed in various embodiments in conjunction with techniques for scale parameter estimation and/or tuning. The logic flow 400 may be representative of some or all of the operations that may be executed by one or more components/devices/environments/flows described herein, such as binary neural network trainer 104, parameter tuner 108, 208, gradient estimator 110, 210, parameter estimator 112, 212, and/or process flow 300, or components thereof. The embodiments are not limited in this context.

In the illustrated embodiment, logic flow 400 may begin at block 402. At block 402 “determine a quantization error and a clipping error associated with generation of a neural network, the neural network comprising at least one binary activation layer” a quantization error and a clipping error associated with training a neural network comprising at least one binary activation layer may be determined. For example, parameter tuner 108 may determine a quantization error and a clipping error associated with training binary neural network 106. In several embodiments, the parameter tuner 108 may be included in a binary neural network trainer 104.

Proceeding to block 404 “estimate a gradient for a scale parameter based on the quantization error and the clipping error, the scale parameter associated with activations in the neural network” a gradient for a scale parameter associated with activations in the neural network may be estimated based on the quantization error and the clipping error. For instance, gradient estimator 210 may determine scale parameter gradient estimation 230 based on clipping error 220 and quantization error 222. In some embodiments, the gradient estimator 210 may determine a clipping error “force” 224 and a quantization error “force” 226 based on the clipping error 220 and the quantization error 222. In some such embodiments, the gradient estimator 210 may determine the scale parameter gradient estimation 230 based on the clipping error “force” 224 and the quantization error “force” 226.

Continuing to block 406 “tune the scale parameter based on the gradient estimated for the scale parameter” the scale parameter may be tuned based on the gradient estimated for the scale parameter. For example, parameter estimator 212 may tune a current scale parameter 234 based on the scale parameter gradient estimation 230 to produce an updated scale parameter 236. In various embodiments, the parameter estimator 212 may be included in a binary neural network trainer 104.

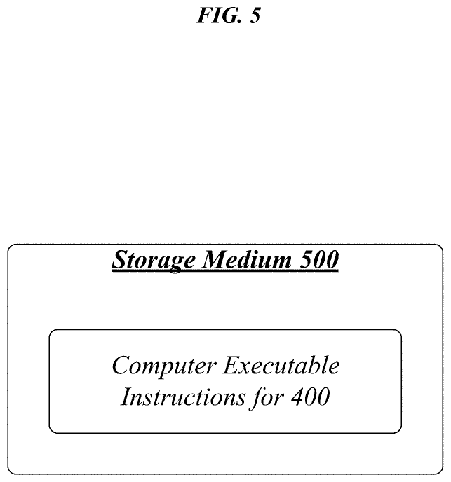

FIG. 5 illustrates an embodiment of a storage medium 500. Storage medium 500 may comprise any non-transitory computer-readable storage medium or machine-readable storage medium, such as an optical, magnetic or semiconductor storage medium. In various embodiments, storage medium 500 may comprise an article of manufacture. In some embodiments, storage medium 500 may store computer-executable instructions, such as computer-executable instructions to implement one or more of logic flows or operations described herein, such as with respect to logic flow 400 of FIG. 4. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

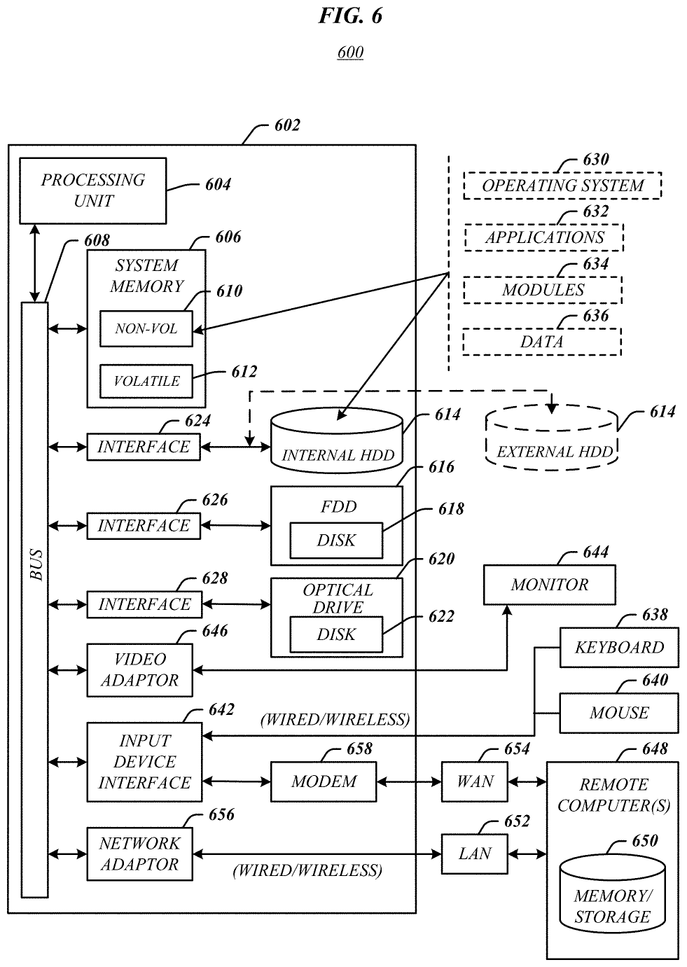

FIG. 6 illustrates an embodiment of an exemplary computing architecture 600 that may be suitable for implementing various embodiments as previously described. In various embodiments, the computing architecture 600 may comprise or be implemented as part of an electronic device. In some embodiments, the computing architecture 600 may be representative, for example, of one or more components described herein. In some embodiments, computing architecture 600 may be representative, for example, of a computing device that implements or utilizes one or more portions of components and/or techniques described herein, such as binary neural network trainer 104, parameter tuner 108, 208, gradient estimator 110, 210, parameter estimator 112, 212, and/or process flow 300, or components thereof. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. In some embodiments, system memory 606 may include main memory. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by an HDD interface 624, an FDD interface 626 and an optical drive interface 628, respectively. The HDD interface 624 for external drive implementations can include at least one or both of Universal Serial Bus (USB) and Institute of Electrical and Electronics Engineers (IEEE) 994 interface technologies. In various embodiments, these types of memory may not be included in main memory or system memory.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include or implement, for example, the various techniques, applications, and/or components described herein.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608 but can be connected by other interfaces such as a parallel port, IEEE 994 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. In various embodiments, one or more interactions described herein may occur via the networked environment. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654 or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

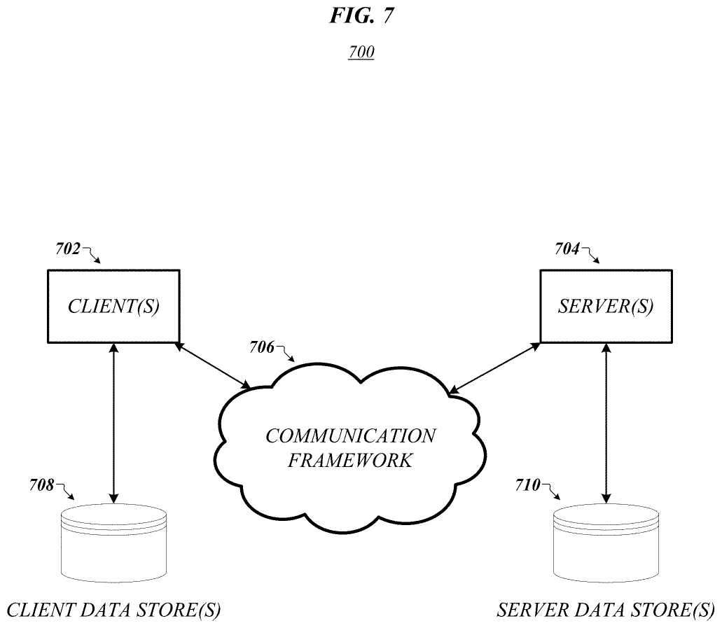

FIG. 7 illustrates a block diagram of an exemplary communications architecture 700 suitable for implementing various techniques and/or embodiments as previously described, such as embodiments of binary neural network trainer 104, parameter tuner 108, gradient estimator 110, and/or parameter estimator 112. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. In some embodiments, communications architecture may include or implement one or more portions of components, applications, and/or techniques described herein. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described herein, such as in conjunction with storage of data received from any one of clients 702 on any of server data stores 710. In one or more embodiments, one or more of client data store(s) 708 or server data store(s) 710 may include memory accessible to one or more portions of components, applications, and/or techniques described herein.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 is an apparatus, comprising: a processor; and memory comprising instructions that when executed by the processor cause the processor to: determine a quantization error and a clipping error associated with generation of a neural network, the neural network comprising at least one binary activation layer; estimate a gradient for a scale parameter based on the quantization error and the clipping error, the scale parameter associated with activations in the neural network; and tune the scale parameter based on the gradient estimated for the scale parameter.

Example 2 includes the subject matter of Example 1, the memory comprising instructions that when executed by the processor cause the processor to tune the scale parameter as part of a stochastic gradient descent optimization loop.

Example 3 includes the subject matter of Example 1, wherein the scale parameter defines a binary level for at least one activation in the neural network.

Example 4 includes the subject matter of Example 1, wherein the neural network comprises a convolutional neural network.

Example 5 includes the subject matter of Example 1, the memory comprising instructions that when executed by the processor cause the processor to: compare an activation value to a threshold; and map the activation value to a binary system based on comparison of the activation value to the threshold.

Example 6 includes the subject matter of Example 5, the memory comprising instructions that when executed by the processor cause the processor to utilize a sigmoid function to parameterize the threshold.

Example 7 includes the subject matter of Example 1, the memory comprising instructions that when executed by the processor cause the processor to utilize one or more of an exponentiation function and a logarithmic function to generate the scale parameter.

Example 8 includes the subject matter of Example 1, the memory comprising instructions that when executed by the processor cause the processor to utilize the scale parameter to train a binary neural network.

Example 9 includes the subject matter of Example 1, the memory comprising instructions that when executed by the processor cause the processor to estimate a gradient for a scale parameter based on the quantization error and the clipping error with:

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

Example 10 includes the subject matter of Example 1, the memory comprising instructions that when executed by the processor cause the processor to parameterize scale to make optimization adjustment size proportional to scale value.

Example 11 includes the subject matter of Example 1, the memory comprising instructions that when executed by the processor cause the processor to parameterize threshold to make optimization adjustments larger for threshold values closer to 0.5 than 0 and 1 and smaller for threshold values closer to 0 or 1 than 0.5.

Example 12 includes the subject matter of Example 1, the memory comprising instructions that when executed by the processor cause the processor to utilize the scale parameter to train a binary neural network.

Example 13 includes the subject matter of Example 1, the memory comprising instructions that when executed by the processor cause the processor to utilize a first optimization adjustment size for a first scale parameter value and a second optimization adjustment size for a second scale parameter value, wherein the first optimization adjustment size is larger than the second optimization adjustment size and the first scale parameter value is larger than the second scale parameter value.

Example 14 is at least one non-transitory computer-readable medium comprising a set of instructions that, in response to being executed by a processor circuit, cause the processor circuit to: determine a quantization error associated with generation of a neural network, the neural network comprising at least one binary activation layer; estimate a gradient for a scale parameter based on the quantization error, the scale parameter associated with activations in the neural network; and tune the scale parameter based on the gradient estimated for the scale parameter.

Example 15 includes the subject matter of Example 14, comprising instructions that, in response to being executed by the processor circuit cause the processor circuit to: determine a clipping error associated with generation of the neural network; and estimate the gradient for the scale parameter based on the quantization error and the clipping error.

Example 16 includes the subject matter of Example 15, comprising instructions that, in response to being executed by the processor circuit cause the processor circuit to estimate the gradient for the scale parameter based on the quantization error and the clipping error with:

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

Example 17 includes the subject matter of Example 14, wherein the scale parameter defines a binary level for at least one activation in the neural network.

Example 18 includes the subject matter of Example 14, wherein the neural network comprises a convolutional neural network.

Example 19 includes the subject matter of Example 14, comprising instructions that, in response to being executed by the processor circuit cause the processor circuit to determine a first gradient based on an inverse of the scale parameter to estimate the gradient for the scale parameter.

Example 20 includes the subject matter of Example 19, comprising instructions that, in response to being executed by the processor circuit cause the processor circuit to determine a second gradient based on the scale parameter to estimate the gradient for the scale parameter.

Example 21 includes the subject matter of Example 14, comprising instructions that, in response to being executed by the processor circuit cause the processor circuit to tune the scale parameter as part of a stochastic gradient descent optimization loop.

Example 22 includes the subject matter of Example 14, comprising instructions that, in response to being executed by the processor circuit cause the processor circuit to: compare an activation value to a threshold; and map the activation value to a binary system based on comparison of the activation value to the threshold.

Example 23 includes the subject matter of Example 22, comprising instructions that, in response to being executed by the processor circuit cause the processor circuit to utilize a sigmoid function to parameterize the threshold.

Example 24 includes the subject matter of Example 14, comprising instructions that, in response to being executed by the processor circuit cause the processor circuit to utilize one or more of an exponentiation function and a logarithmic function to generate the scale parameter.

Example 25 includes the subject matter of Example 14, comprising instructions that, in response to being executed by the processor circuit cause the processor circuit to parameterize scale to make optimization adjustment size proportional to scale value.

Example 26 includes the subject matter of Example 14, comprising instructions that, in response to being executed by the processor circuit cause the processor circuit to parameterize threshold to make optimization adjustments larger for threshold values closer to 0.5 than 0 and 1 and smaller for threshold values closer to 0 or 1 than 0.5.

Example 27 is a computer-implemented method, comprising: determining a quantization error associated with generation of a neural network, the neural network comprising at least one binary activation layer; estimating a gradient for a scale parameter based on the quantization error, the scale parameter associated with activations in the neural network; and tuning the scale parameter based on the gradient estimated for the scale parameter.

Example 28 includes the subject matter of Example 27, comprising: determining a clipping error associated with generation of the neural network; and estimating the gradient for the scale parameter based on the quantization error and the clipping error.

Example 29 includes the subject matter of Example 28, comprising estimating the gradient for the scale parameter based on the quantization error and the clipping error with:

$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

Example 30 includes the subject matter of Example 27, wherein the scale parameter defines a binary level for at least one activation in the neural network.

Example 31 includes the subject matter of Example 27, wherein the neural network comprises a convolutional neural network.

Example 32 includes the subject matter of Example 27, comprising determining a first gradient based on an inverse of the scale parameter to estimate the gradient for the scale parameter.

Example 33 includes the subject matter of Example 32, comprising determining a second gradient based on the scale parameter to estimate the gradient for the scale parameter.

Example 34 includes the subject matter of Example 27, comprising tuning the scale parameter as part of a stochastic gradient descent optimization loop.

Example 35 includes the subject matter of Example 27, comprising: comparing an activation value to a threshold; and mapping the activation value to a binary system based on comparison of the activation value to the threshold.

Example 36 includes the subject matter of Example 35, comprising utilizing a sigmoid function to parameterize the threshold.

Example 37 includes the subject matter of Example 27, comprising utilizing one or more of an exponentiation function and a logarithmic function to generate the scale parameter.

Example 38 includes the subject matter of Example 27, comprising parameterizing scale to make optimization adjustment size proportional to scale value.

Example 39 includes the subject matter of Example 27 27, comprising parameterizing threshold to make optimization adjustments larger for threshold values closer to 0.5 than 0 and 1 and smaller for threshold values closer to 0 or 1 than 0.5.

Example 40 is an apparatus, comprising: means for determining a quantization error associated with generation of a neural network, the neural network comprising at least one binary activation layer; means for estimating a gradient for a scale parameter based on the quantization error, the scale parameter associated with activations in the neural network; and means for tuning the scale parameter based on the gradient estimated for the scale parameter.

Example 41 includes the subject matter of Example 40, comprising: means for determining a clipping error associated with generation of the neural network; and means for estimating the gradient for the scale parameter based on the quantization error and the clipping error.

Example 42 includes the subject matter of Example 40, comprising means for tuning the scale parameter as part of a stochastic gradient descent optimization loop.

Example 43 includes the subject matter of Example 40, wherein the scale parameter defines a binary level for at least one activation in the neural network.

Example 44 includes the subject matter of Example 40, wherein the neural network comprises a convolutional neural network.

Example 45 includes the subject matter of Example 40, comprising means for determining a first gradient based on an inverse of the scale parameter to estimate the gradient for the scale parameter.

Example 46 includes the subject matter of Example 45, comprising means for determining a second gradient based on the scale parameter to estimate the gradient for the scale parameter.

Example 47 includes the subject matter of Example 46, comprising means for summing the first gradient and the second gradient to estimate the gradient for the scale parameter.

Example 48 includes the subject matter of Example 40, comprising: means for comparing an activation value to a threshold; and means for mapping the activation value to a binary system based on comparison of the activation value to the threshold.

Example 49 includes the subject matter of Example 48, comprising means for utilizing a sigmoid function to parameterize the threshold.

Example 50 includes the subject matter of Example 40, comprising means for utilizing one or more of an exponentiation function and a logarithmic function to generate the scale parameter.

Example 51 includes the subject matter of Example 40, comprising means for utilizing the scale parameter to train a binary CNN.

Example 52 includes the subject matter of Example 40, comprising means for utilizing a first optimization adjustment size for a first scale parameter value and a second optimization adjustment size for a second scale parameter value, wherein the first optimization adjustment size is larger than the second optimization adjustment size and the first scale parameter value is larger than the second scale parameter value.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

1-25. (canceled)

26. An apparatus, comprising:
a processor; and
memory comprising instructions that when executed by the processor cause the processor to:
determine a quantization error and a clipping error associated with generation of a neural network, the neural network comprising at least one binary activation layer;
estimate a gradient for a scale parameter based on the quantization error and the clipping error, the scale parameter associated with activations in the neural network; and
tune the scale parameter based on the gradient estimated for the scale parameter.

27. The apparatus of claim 26, the memory comprising instructions that when executed by the processor cause the processor to tune the scale parameter as part of a stochastic gradient descent optimization loop.

28. The apparatus of claim 26, wherein the scale parameter defines a binary level for at least one activation in the neural network.

29. The apparatus of claim 26, wherein the neural network comprises a convolutional neural network.

30. The apparatus of claim 26, the memory comprising instructions that when executed by the processor cause the processor to:
compare an activation value to a threshold; and
map the activation value to a binary system based on comparison of the activation value to the threshold.

31. The apparatus of claim 30, the memory comprising instructions that when executed by the processor cause the processor to utilize a sigmoid function to parameterize the threshold.

32. The apparatus of claim 26, the memory comprising instructions that when executed by the processor cause the processor to utilize one or more of an exponentiation function and a logarithmic function to generate the scale parameter.

33. The apparatus of claim 26, the memory comprising instructions that when executed by the processor cause the processor to utilize the scale parameter to train a binary neural network.

34. The apparatus of claim 26, the memory comprising instructions that when executed by the processor cause the processor to estimate a gradient for a scale parameter based on the quantization error and the clipping error with:
$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

35. The apparatus of claim 26, the memory comprising instructions that when executed by the processor cause the processor to parameterize scale to make optimization adjustment size proportional to scale value.

36. The apparatus of claim 26, the memory comprising instructions that when executed by the processor cause the processor to parameterize threshold to make optimization adjustments larger for threshold values closer to 0.5 than 0 and 1 and smaller for threshold values closer to 0 or 1 than 0.5.

37. At least one non-transitory computer-readable medium comprising a set of instructions that, in response to being executed by a processor circuit, cause the processor circuit to:
determine a quantization error associated with generation of a neural network, the neural network comprising at least one binary activation layer;
estimate a gradient for a scale parameter based on the quantization error, the scale parameter associated with activations in the neural network; and
tune the scale parameter based on the gradient estimated for the scale parameter.

38. The at least one non-transitory computer-readable medium of claim 37, comprising instructions that, in response to being executed by the processor circuit cause the processor circuit to:
determine a clipping error associated with generation of the neural network; and
estimate the gradient for the scale parameter based on the quantization error and the clipping error.

39. The at least one non-transitory computer-readable medium of claim 38, comprising instructions that, in response to being executed by the processor circuit cause the processor circuit to estimate the gradient for the scale parameter based on the quantization error and the clipping error with:
$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$

40. The at least one non-transitory computer-readable medium of claim 37, comprising instructions that, in response to being executed by the processor circuit cause the processor circuit to tune the scale parameter as part of a stochastic gradient descent optimization loop.

41. The at least one non-transitory computer-readable medium of claim 37, wherein the scale parameter defines a binary level for at least one activation in the neural network.

42. The at least one non-transitory computer-readable medium of claim 37, comprising instructions that, in response to being executed by the processor circuit cause the processor circuit to parameterize scale to make optimization adjustment size proportional to scale value.

43. A computer-implemented method, comprising:
determining a quantization error associated with generation of a neural network, the neural network comprising at least one binary activation layer;
estimating a gradient for a scale parameter based on the quantization error, the scale parameter associated with activations in the neural network; and
tuning the scale parameter based on the gradient estimated for the scale parameter.

44. The computer-implemented method of claim 43, comprising:
determining a clipping error associated with generation of the neural network; and
estimating the gradient for the scale parameter based on the quantization error and the clipping error.

45. The computer-implemented method of claim 44, comprising estimating the gradient for the scale parameter based on the quantization error and the clipping error with:
$$Δ L / Δ {S}_{ln} = \{ \begin{matrix}0 & for & X \leq 0 \\ ( {Y}_{b} - X ) \cdot Δ L / Δ {Y}_{b} & for & 0 < X < S \\ S \cdot Δ L / Δ {Y}_{b} & for & X \geq S\end{matrix}$$
